(19) United States
(12) Patent Application Publication
(10) Pub. No.: US 2005/0100083 A1
(43) Pub. Date: May 12, 2005

(54) Full duplex transmission method

(76) Inventors: Hiroshi Takatori, Sacramento, CA (US); James Little, Sacramento, CA (US); Susumu Hara, Austin, TX (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/932,931

(22) Filed: Sep. 1, 2004

Related U.S. Application Data
(60) Provisional application No. 60/512,571, filed on Oct. 16, 2003.

(51) Int. Cl. H04B 1/38

(52) U.S. Cl. 375/220; 375/257

(57) ABSTRACT

High speed data communication standards such as IEEE 802.3ae (also known as XAUI) use four lanes to transmit data half duplex at 10 Gb/s. In order to achieve full duplex, eight lanes need to be used. By introducing echo cancellers into the system, a high speed transceiver can be built with full duplex capability on four lanes, thereby saving 50% of the lane requirements when compared to XAUI while still maintaining a low symbol rate.

### RELATED APPLICATIONS

This application claims priority under 35 U.S.C. § 119(e) to provisional application No. 60/512,571 filed on Oct. 16, 2003 titled “Full Duplex 10 Gb/s Transmission Method.”

### FIELD

The invention relates to data transmission, and, more specifically, high speed full duplex transmission.

### BACKGROUND

In recent years, bandwidth requirements for digital communications switching equipment have risen to 40 Gb/s per line card. A fundamental limitation for equipment manufacturers is the bottleneck that exists when moving high-speed data back and forth within the chassis of a piece of communications equipment. Recent IEEE standards such as IEEE 802.3ae have defined a four-lane architecture to achieve a 10 Gb/s data communication system. This architecture, also known as XAUI, uses a four-lane parallel structure. The four lane arrangement is used, because a single serial structure would require too high of a symbol rate and the limited bandwidth of printed circuit board (PCB) traces would not be able to support it. Each lane uses differential signaling across two traces (or wires).

The four lane XAUI standard comprises half duplex communication. Thus, in order to achieve full duplex communications, eight lanes are required for the XAUI standard. As data rate per line card exceed 40 Gb/s, material limitations will prove difficult to overcome. It is advantageous to maintain the lowest possible signaling rate, at a minimal power, in order to enable future increases in data rates.

The XAUI standard is defined by IEEE 802.3ae and comprises a four-lane structure. Each lane uses one pair of wires (or PCB traces) and a 2.5 Gb/s data transmission rate. The actual bit rate on each wire pair is 3.125 Gb/s including 8b10b encoding overhead, which is added to maintain the DC balance of the differential pair. A total data rate of 12.5 Gb/s is used for one direction. A similar four-lane structure is needed for the opposite half duplex direction. Therefore, a total of 16 pins, or traces, is required for full duplex communication for the XAUI interface. The binary transmitted signal on each lane, or pair of traces, represents the high and low levels corresponding to the data 1 and 0 respectively. The two state differential transmission corresponds with a two level pulse amplitude modulation (PAM) scheme. The symbol speed of the binary signal is 3.125 Gb/s. Thus, 3.125 Gb/s of information with 8b10b overhead can be transmitted if there are no errors.

FIG. 1 shows an example of the XAUI standard. First and second transceivers 102, 104 can both receive and transmit data at 10 Gb/s. Four lanes 106 are used to transmit data from the first transceiver 102 to the second transceiver 104. Similarly, four lanes 108 are used to transmit data from the second transceiver 104 to the first transceiver 102. A total of eight lanes are used for full duplex communication.

There have been attempts to improve the transmission efficiency by using PAM levels greater that two. One example of a system proposes increasing in the increasing the number of PAM levels for the line code from 2 to 4. This increases the number of bits transmitted by each lane and, thus, increases the data rate. For example, by using a 4 level PAM and a 3.125 Gb/s symbol rate, only four lanes are needed to achieve full duplex at 10 Gb/s. This saves half of the lanes one compared to the XAUI interface.

Other attempts to improve transmission efficiency include increasing number of PAM levels from 2 to 5. The fifth level is often used for error coding. This increases the number of bits transmitted by each lane, thereby increasing the data rate. For example, by using a 5 level PAM with a 2.5 Gb/s symbol rate, only four lanes are you needed to achieve full duplex at 10 Gb/s.

Still other attempts include increasing the symbol rate rather than the PAM level. For example, by using a 2 level PAM with a 6.25 Gb/s symbol rate, only four lanes are needed to achieve full duplex at 10 Gb/s. One can speed up the symbol rate even more, to 12.5 Gb/s, for example, to achieve full duplex on only two lanes.

All of these prior art attempts are understood to increase throughput of the data by either increasing the PAM level, increasing the symbol rate, or a combination of both. In fact, the ultimate goal these methods is to reduce the number of pins, or number of PCB traces, to achieve a certain data rate. At the same time, these prior art methods do not address the desirability of a low symbol rate in order to achieve reliable communications.

One skilled in the art will realize that it is almost always advantageous to reduce the number of traces in digital system. There is a need for a full duplex 10 Gb/s or greater communication system with a minimal number of traces, low power consumption, and minimal symbol rates.

### SUMMARY

This document describes a method and apparatus for high speed duplex data communication.

### BRIEF DESCRIPTION OF DRAWINGS

FIG. 1 shows an example of the XAUI standard.

FIG. 2 shows an example of full duplex communication on four lanes.

FIG. 3 shows an example of full duplex communication on one lane.

FIG. 4 shows various elements of a transceiver.

FIG. 5 shows an example of communication on a PCB.

FIG. 6 shows an example of communication in a backplane.

### DESCRIPTION

The number of lanes used for full duplex communication in high speed systems can be cut in half by using full duplex communications on the lanes provided.

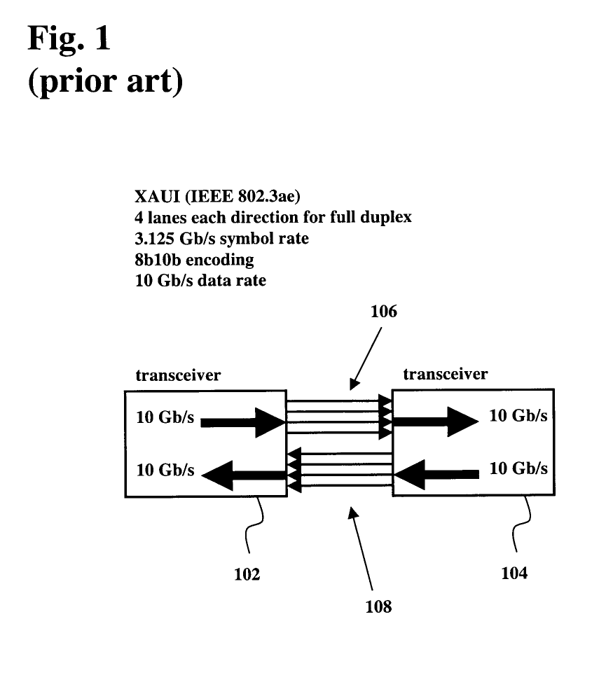

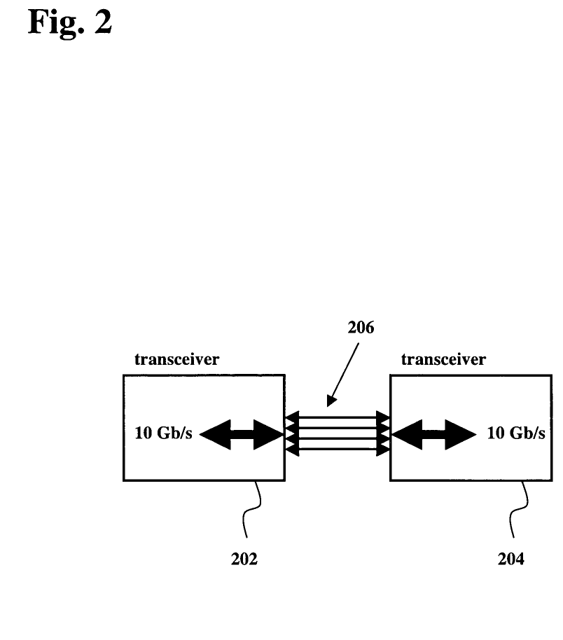

FIG. 2 shows an example of full duplex communication on four lanes. First and second transceivers 202, 204 can both receive and transmit data at 10 Gb/s over the four lanes 206. Compared to that which is shown in FIG. 1, only half the number of lanes are required to achieve full duplex at a 10 Gb/s data rate.

Full duplex communication on a lane can be achieved with the use of an echo canceller. Echo cancellers generally remove traces of a transmitted signal from the received signal before a signal decoder receives the far end signal. That way, the signal decoder does not become confused by data transmitted by its own transmitter.

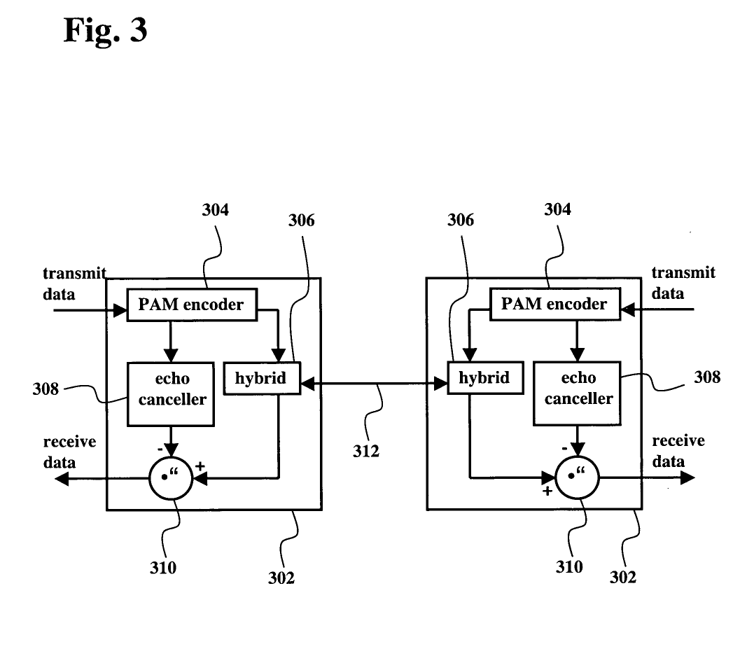

FIG. 3 shows an example of full duplex communication on one lane. Two transceivers 302 are connected with one lane 312. Each transceiver 302 includes a PAM encoder (line driver) 304, a hybrid 306, an echo canceller 308, and a summing node 310. For simplicity of the example, other elements of the transceivers 302 are not shown. A PAM encoder 304 receives the transmission data from the rest of the system and converts the digital data to the differential PAM signal. The PAM encoder 304 sends the PAM signal to both the hybrid 306 and the echo canceller 308. The hybrid 306 simultaneously transmits the transmit signal on the lane 312 and receives the incoming signal. The output of the hybrid 306 is the received signal with the transmit signal removed. It is not always possible for the hybrid 306 to completely remove traces of the transmit signal from the received signal. The echo canceller 308, possibly along with other components, detects any part of the transmit signal in the received signal that leaves the hybrid 306. The echo canceller 308 then sends an appropriate signal to the summing node 310 to remove the transmit signal elements from the received signal before the received signal is decoded.

By using this scheme, full duplex communication can be achieved on one lane. For a 10 Gb/s data rate with 8b10b encoding, a symbol rate of 3.125 Gb/s with two level PAM is used over four lanes to achieve full duplex communication.

There may be significant signal integrity gains to be had by using four level PAM in combination with echo cancellation instead of two level PAM. Therefore, one alternate method is to use full duplex 4 level PAM at a 6.25 Gb/s symbol rate on one lane. Another alternate method is to use full duplex 4 level PAM at a 3.125 Gb/s symbol rate on two lanes. Still another alternate method is to use full duplex 4 level PAM at a 1.5625 Gb/s symbol rate on four lanes. Each of these 4 level PAM methods achieves a full duplex 10 Gb/s data rate. One will recognize the pattern and realize that many other combinations are possible with four level PAM when used in combination with echo cancellation.

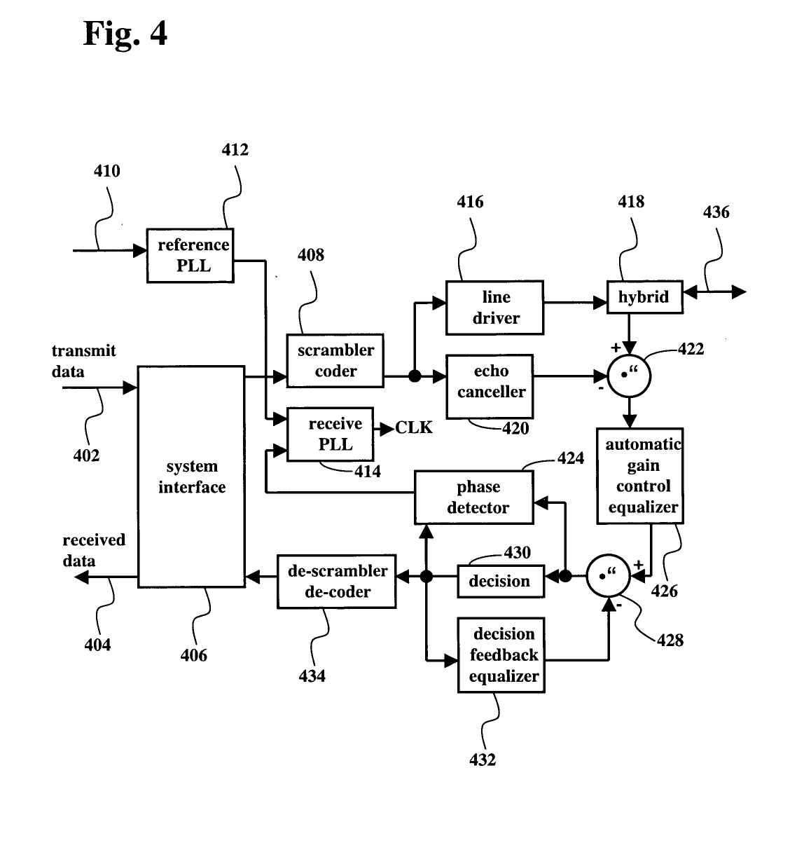

FIG. 4 shows various elements of a transceiver. The system interface 406 receives transmit data 402 and sends received data 404. The system interface sends transmit data to the scrambler coder 408. The scrambler coder 408 mixes the transmit data to reduce any possibility of DC offset on the PCB trace. The scrambler coder 408 sends the transmit data to both the line driver 416 and the echo canceller 420. The line driver 416 converts the transmit data to multilevel PAM, amplifies the signal, and sends it to the hybrid 418. The hybrid 418 sends the transmit signal out and receives the received signal from the lane 436. More than one lane 436 may be necessary, based on the scheme used. If more than one lane is employed, other components of the transceiver may also have multiple instances. The hybrid 418 removes most of the transmit signal from the received signal. The output of the echo canceller 420 in combination with the summing node 422 removes most, if not all, of the remaining transmit signal from the received signal.

The automatic gain control equalizer 426 adjusts the level of the incoming signal to ensure the receiver sees a relatively constant range of signals. The decision block 430 determines the PAM level symbol being received. The decision feedback equalizer 432 adjusts the incoming signals based on the errors seen after the data decision is made. The phase detector 424 compares the clock generating by the receive PLL 414 and the incoming data edges. It feeds this delta to the receive PLL 414 for clock adjustment. The de-scrambler 434 returns the scrambled data being received back to its original order. The reference PLL 412 generates a master clock that is used to clock the entire device. The receive PLL 414 adjusts the clock generated by the reference PLL 412 to align it with the data being received. This allows the receiver to sample data at the optimized location.

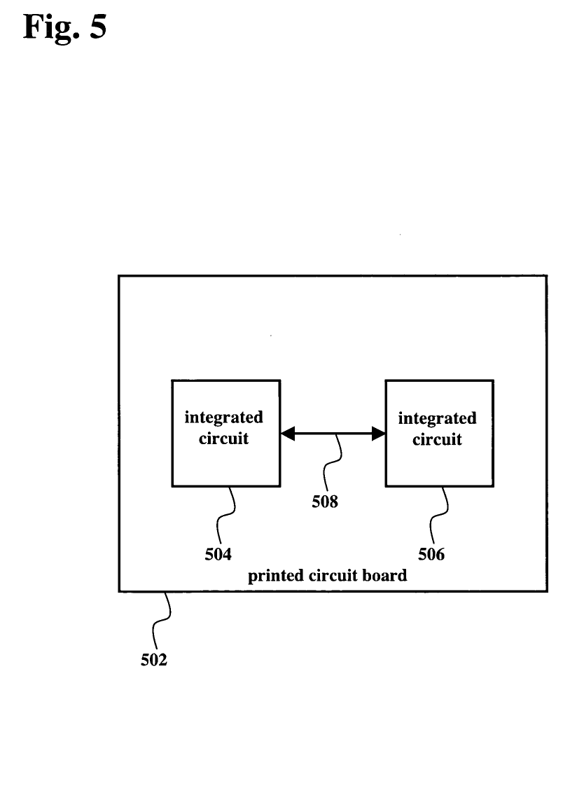

FIG. 5 shows an example of communication on a PCB. One integrated circuit (IC) 504 communicates with another IC 506 via one or more lanes 508 on a PCB 502. The method and system for full duplex communication discussed above can be used on a PCB.

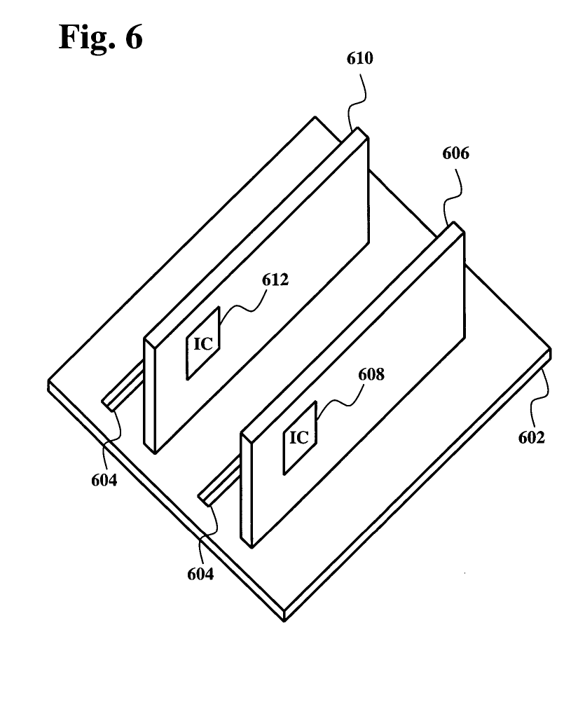

FIG. 6 shows an example of communication in a backplane. The backplane 602 contains several slots 604. Printed circuit boards are inserted into the slots 604 to add functionality to a system. In this example, a PCB 606 contains an IC 608 that communicates with another PCB 610 that contains an IC 612 across the backplane 602. Not shown are the one or more lanes used for the communication. The method and system for full duplex communication discussed above can be used in a backplane.

It will be apparent to one skilled in the art that the described embodiments may be altered in many ways without departing from the spirit and scope of the invention. Accordingly, the scope of the invention should be determined by the following claims and their equivalents.

1. A data transmission system comprising:
a first transceiver;
a second transceiver; and
at least one data lane connecting the first and second transceivers,
where each transceiver has an echo canceller.

2. The system of claim 1, wherein the at least one lane travels through a backplane.

3. The system of claim 1, wherein the at least one lane comprises a trace on a printed circuit board.

4. The system of claim 1, wherein data transmission on the at least one lane is full duplex.

5. The system of claim 1, wherein data transmission speed is at least 10 gigabits per second.

6. The system of claim 1, wherein a data signal comprises a pulse amplitude modulated signal with at least four levels.

7. The system of claim 1, wherein the at least one data lane comprises one signal pair of traces with a symbol rate of at least 6.25 gigabits per second.

8. The system of claim 1, wherein the at least one data lane comprises two signal pair of traces, each pair having a symbol rate of at least 3.125 gigabits per second.

9. The system of claim 1, wherein the at least one data lane comprises four signal pair of traces, each pair having a symbol rate of at least 1.5625 gigabits per second.

10. The system of claim 1, wherein the echo cancellers remove signal reflections and transmission signal elements from signals received by their respective transceivers.

11. The system of claim 1, wherein each transceiver includes a hybrid, each hybrid removing a majority of transmission signal elements from a received signal that is fed to a receiver portion of the respective transceiver.

12. A method of data communication comprising:
sending a multilevel PAM signal from a first transceiver to a second transceiver; and
sending a multilevel PAM signal from the second transceiver to the first transceiver,
where signal transmission on at least one lane is full duplex.

13. The system of claim 12, wherein the first and second transceivers each use an echo canceller to remove elements of a transmitted signal from a received signal.

14. A data transmission system comprising:
a first transceiver;
a second transceiver; and
four data lanes connecting the first and second transceivers,
where each transceiver has an echo canceller, each echo canceller removing signal reflections and transmission signal elements from received signals by their respective transceivers,
where the lanes travels through a backplane,
where data transmission on the lanes is full duplex,
where data transmission speed is at least 10 gigabits per second,
where a data signal comprises a pulse amplitude modulated signal with at least four levels,
where each lane has a symbol rate of at least 1.5625 gigabits per second,
where each transceiver includes a hybrid, each hybrid removing a majority of transmission signal elements from a received signal that is fed to a receiver portion of the respective transceiver.
